(19) United States
(12) Patent Application Publication
(10) Pub. No.: US 2011/0107971 A1
(43) Pub. Date: May 12, 2011

(54) MILKING SYSTEM, A TEAT CUP AND A TEAT CUP LINER

(75) Inventor: Torbjorn Petterson, Gnesta (SE)

(73) Assignee: DELAVAL HOLDING AB, Tumba (SE)

(21) Appl. No.: 13/003,579

(22) PCT Filed: Jul. 9, 2009
(86) PCT No.: PCT/EP2009/058751

§ 371 Date: Jan. 11, 2011

(30) Foreign Application Priority Data
Jul. 16, 2008 (SE) 0801700-6

(51) Int. Cl. A01J 5/04; A01J 5/007

(52) U.S. Cl. 119/14.08; 119/14.38; 119/14.47

(57) ABSTRACT

A milking system (1) includes a vacuum supply source (3) and a teat cup (2). The teat cup (2) includes a teat cup liner (11) and a teat cup shell (10), with the teat cup shell (10) connected at plural points to the vacuum supply source (3). The teat cup liner (11) is arranged to support and fit tight to a teat of a milking animal throughout a milking session, whereby a uniform pressure is applied to the teat throughout the milking session so that a milking that is more comfortable for the milking animal is accomplished.

### FIELD OF THE INVENTION

The invention relates generally to the field of milking, and in particular to milking systems comprising teat cups with teat cup liners.

### BACKGROUND OF THE INVENTION

Machine milking was developed in order to alleviate the labour involved in milking. The milking systems have been designed to be as natural as possible, but a lifelike mimicking of the milk extraction by a calf is not possible due to efficiency requirements in machine milking systems. For example, although it would probably be comfortable for a cow to have milk extracted from one teat at a time, and changing teat with a frequency equal to the frequency used by a calf, this would be a too time-consuming and inefficient solution.

In today's milking, a teat cup used for extracting milk comprises a teat cup liner designed to collapse cyclically against the teat by means of a pulsator that alternates between subatmospheric pressure and atmospheric pressure. Such vacuum application causes the teat cup liner to alternately contract and expand. In the contraction state, the teat cup liner collapses against the teat and in the expansion state the teat cup liner opens to original shape.

It has been noted that the vacuum causes blood and tissue fluids to accumulate in tissue of the tip of the teat, or teat end, causing the teat end to get congested. The tissue volume may be doubled during milking and the accumulation of fluids in the teat end causes a local circulation disturbance. The fluid accumulations and tissue swelling in turn cause the teat canal to contract, which leads to a reduced milk flow.

In the conventional milking systems this is counteracted by a massaging effect on the teat by the teat cup liner when it collapses around the teat in the pulsation cycle. The fluids are then pushed towards the udder and the teat canal is kept open.

Further, there are some shortcomings of prior art teat cup liners. During milking, there may be crawling of the teat cup liner towards the end of the milking session when the udder pressure decreases and the teat size is lessened. When the teat cup crawls upwards on the teat towards the udder this may cause a cut-off of the milk canal interior of the teat close to the udder, which is uncomfortable for the milking animal and disturbs the milking. Another shortcoming related to known teat cup liners is that the fit between the teat cup liner and teat varies for different teats, and for some teat shapes pinching of the teat may occur when the teat cup liner collapses against the teat. Further, due to ill-fit there may also be a higher pressure on the teat at certain points near the teat end, again causing discomfort. Moreover, when the udder pressure decreases and becomes low, the contact pressure between liner and teat disappears, which leads to crawling of the teat cup and an abrupt ending of the milking of that teat, leaving residual milk in the udder.

Further yet, the crawling may also result in milk flowing from a short milk tube connected to the teat cup back up into the teat cup, due to the fact that the displaced teat cup liner prevents the normal air leakage around the top of the teat cup and creates a higher vacuum in the teat cup than in the short milk tube.

Moreover, the teat end should remain free and not be subjected to slapping by the teat cup liner. Such slapping may still occur during the pulsation cycle when the teat cup liner collapses against the teat. Besides being painful for the milking animal, this poses a health risk to her as this leads to a higher risk of mastitis bacteria entering the teat canal.

Although much research has been done, it is difficult to design a system providing the best compromise between the wellbeing of the milking animal and the efficiency of the milking system. In view of the above it would be desirable to provide a milking system in which the above-described problems are addressed.

### SUMMARY OF THE INVENTION

It is an object of the invention to provide a milking system, wherein the above disadvantages are overcome or at least alleviated.

It is an object of the invention to provide a milking system, wherein the comfort of the milking animal during a milking session is increased. In particular, it is an object of the invention to provide a milking system, wherein milking related shortcomings concerning especially udder and teat care are overcome.

It is another object of the invention to provide a milking system, wherein crawling of teat cup liners or slapping of them against the teat and udder of a milking animal is eliminated.

It is yet another object of the invention to provide a more cost-efficient milking system requiring fewer components and less service and maintenance work.

These objects, among others, are achieved by a milking system and related methods as claimed in the appended claims.

In accordance with the invention a milking system is provided comprising a vacuum supply source and a teat cup. The teat cup comprises a teat cup liner and a teat cup shell, wherein the teat cup shell is connected to the vacuum supply source. The teat cup liner is arranged to support and fit tight to a teat of a milking animal throughout a milking session, whereby a uniform pressure is applied to the teat throughout the milking session. By means of the invention, a milking that is more comfortable for the milking animal is accomplished. In accordance with the invention, the teat cup liner of the teat cup is tight-fitting on the teat and provides a uniform, but possibly varying pressure on the teat. Thereby crawling of the teat cup liner is prevented and problems related thereto are eliminated. For example, as the teat cup is prevented from crawling upwards on the teat towards the udder there is no risk of a cut-off of the milk canal interior of the teat close to the udder. Further, the tight-fitting teat cup liner supports the teat during the whole milking session, and all around the teat without any space between the teat and the teat cup liner at any time. The comfort for the milking animal is thereby highly increased.

In accordance with an embodiment of the invention, the teat cup liner is made of an elastic or thermoelastic material that provides the tight-fitting of the teat cup liner to the teat. The elastic material further admits expansion of the teat cup liner when providing a vacuum level by the vacuum supply source at the first connection point. Further still, the diameter of the teat cup liner is preferably chosen to be smaller than the diameter of the teat, again providing a tight fit. Simple, yet effective ways of providing the desired tight fit and supporting function is thereby presented.

In accordance with still another embodiment of the invention, the teat cup comprises an inlet connector provided with a protruding part, which protrudes to within the teat cup. A simple means is provided for preventing the teat cup liner from expanding more than desired, i.e. expanding so that the teat and the teat cup liner loses contact with each other.

In accordance with yet another embodiment of the invention, a non-pulsating vacuum is applied to the teat, whereby a more cost-efficient milking system requiring fewer components and less service and maintenance work, is provided.

The invention is also related to a teat cup and a teat cup liner, whereby advantages similar to the above are achieved.

### BRIEF DESCRIPTION OF THE DRAWINGS

FIG. 1 illustrates a milking system in accordance with the invention.

FIG. 2 illustrates a teat cup in accordance with the invention.

FIG. 3 illustrates a first embodiment of teat cup liner for use in a milking system in accordance with the invention.

FIG. 4 illustrates a second embodiment of teat cup liner for use in a milking system in accordance with the invention.

FIG. 5 illustrates a third embodiment of teat cup liner for use in a milking system in accordance with the invention.

### DETAILED DESCRIPTION OF EMBODIMENTS OF THE INVENTION

The present invention is applicable to any type of machine milking application, including manual machine milking, wherein teat cups are attached manually, and automated machine milking, wherein teat cups are attached by means of a milking robot. The invention may be practised in any kind of milking parlour, including for example a rotary milking parlour, an automatic milking system, a tied-up environment or a bucket application.

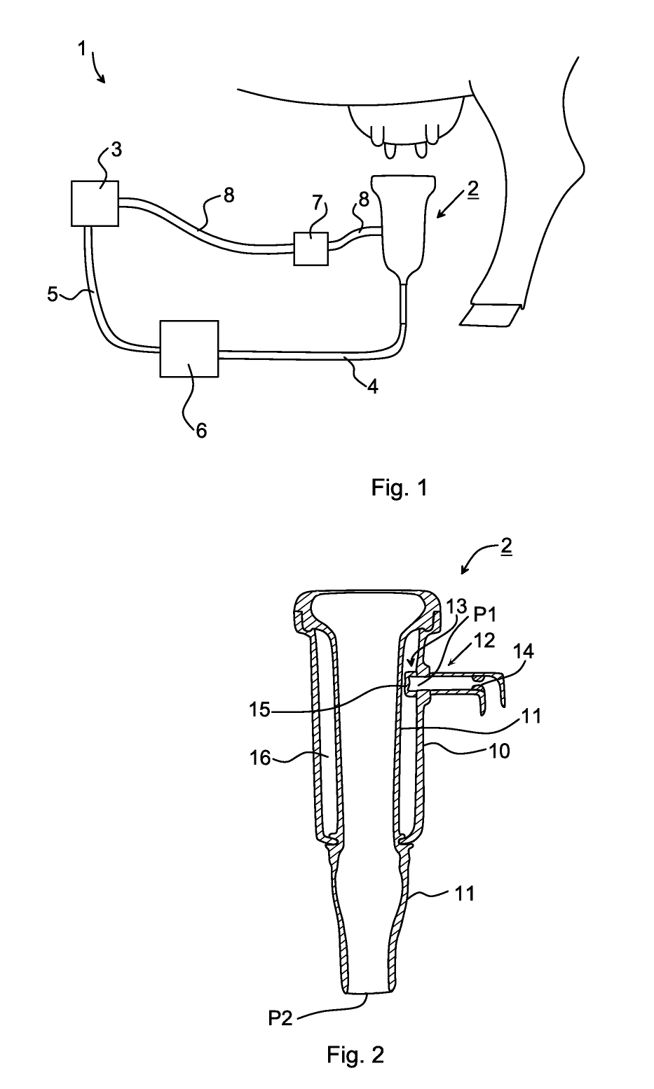

FIG. 1 illustrates a schematic overview of a milking system in accordance with the invention. The milking system 1 comprises a number of teat cups 2 for attachment to the teats of a milking animal such as a cow. There are usually four teat cups 2, although only one is shown for simplicity. Each teat cup 2 may be connected to a respective milk tube 4 (only one shown), the milk tubes 4 further being connected to a milk tank 6. Each teat cup 2 may alternatively be connected via a short milk tube to one milk claw, in turn connected to the milk tank 6 by a single milk tube. Each milk tube 4 may be connected to a milk tank 6, or, via a three-way valve (not illustrated) to any other milk receiving unit or waste container. The milk tank 6 is connected to a vacuum supply source 3 by means of a vacuum tube 5. The vacuum supply source is further connected to each teat cup 2 via a respective vacuum tube 8 (again, only one shown) and a pulsator system 7 for providing a pulsating vacuum.

For clarity, only parts relevant for the invention are disclosed in FIG. 1. It is realized that the milking system 1 may comprise a number of non-disclosed parts, for example a milking robot for gripping and attaching the teat cups to the teats of a milking animal, control means, valves etc.

FIG. 2 illustrates a teat cup 2 for use in the milking system 1 in accordance with the invention. The teat cup 2 comprises a teat cup shell 10 and a teat cup liner 11 mounted thereto. The teat cup liner 11 is mounted in any suitable manner to the teat cup shell 10, but in such manner that a closed space is formed between the teat cup liner 11 and the teat cup shell 10. This closed space 16 forms a pulsating chamber of the teat cup 2 if a pulsating vacuum is provided and a chamber 16 having a certain, essentially constant vacuum level otherwise.

The teat cup shell 10 comprises an inlet connector 12 connected to the vacuum supply source 3, the inlet connector constituting a first vacuum connection point P1. The lower part of the teat cup liner 11, the short milk tube, is connectable to the milk tube 4 via a claw of a milking cluster (not illustrated). The lower part of the teat cup liner 11 is thus connected to a milking vacuum, and constitutes a second vacuum connection point P2. The lower part of the teat cup liner 11 comprises an open end for releasing milk extracted from the teat.

Inlet connector 12 may further comprise an ejector device 14. This is usable if a single vacuum level is supplied. The ejector device 14 provides a higher vacuum level within the teat cup 2 than is provided by the vacuum supply source 3. The contraction and expansion of the teat cup liner 11 is thereby accomplished.

In an embodiment of the teat cup 2, the inlet connector 12 of the teat cup shell 10 is designed so as to have a part 13 that protrudes to the inside of the teat cup shell 10. The protruding part 13 is hollow and has an opening for communicating a vacuum level provided by the vacuum supply source 3. Further, the protruding part 13 preferably has a grating 15 covering its opening.

When the teat cup liner 11 has expanded to a desired degree, the protruding part 13 prevents further expansion by the teat cup liner 11 bearing against the opening of the protruding part 13 and preventing further vacuum from being supplied, i.e. preventing a vacuum increase. Thereby it is ensured that the teat cup liner 11 is in firm, tight-fitting contact with the teat at all times. The length of the protruding part 13, i.e. the length from the wall of the teat cup shell 10 and inwards into the closed space 16 of the teat cup, can be chosen suitably, e.g. in dependence on the teat sizes of the herd of milking animals to be milked. In an alternative embodiment, the length of the protruding part 13 is adjustable.

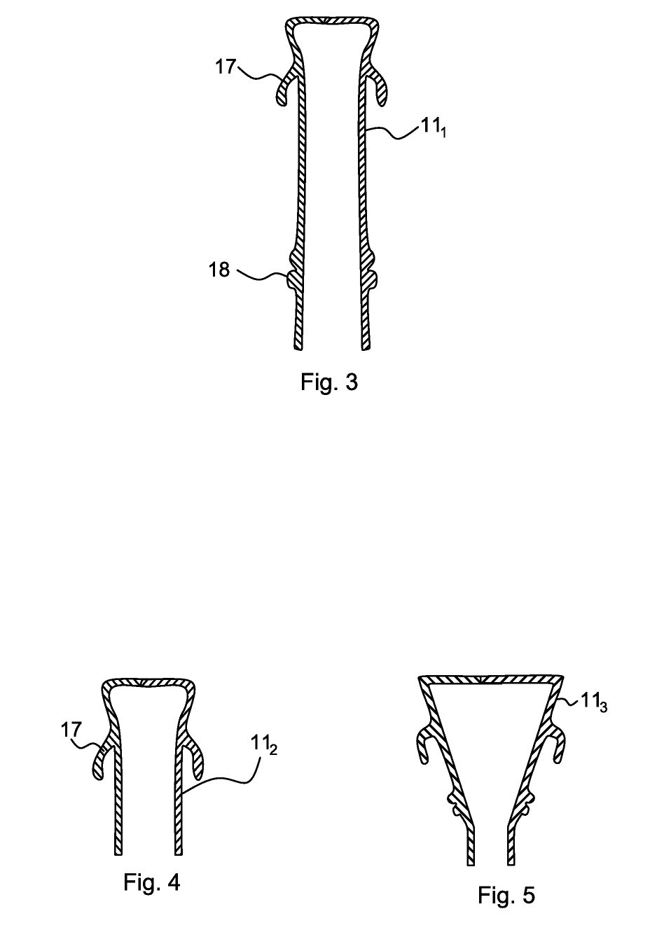

The teat cup liner 11 may have different shapes and three embodiments of the teat cup liner 11 will be described in the following with reference to FIGS. 3, 4 and 5, respectively.

FIG. 3 illustrates a first embodiment of the teat cup liner 11₁ in accordance with the invention. The shape of the teat cup liner 11₁ is similar to a conventional teat cup liner, i.e. it comprises attachment means 17, 18 (schematically shown) for mounting to the teat cup shell 10 at the upper end, and at the lower end, respectively. The connection means 17, 18 should be designed so as to enable the closed space 16 to be formed. The teat cup liner 11₁ may also comprise connection means for connection to a milk line.

When the teat cup 2 is to be attached to the teat, a vacuum is supplied at the first connection point P1. The teat cup liner 11₁ is thereby expanded so that the attachment is accomplished. The lower, rounded part of the teat, i.e. the teat tip, is subjected to the vacuum level supplied at the second connection point P2.

The diameter of the teat cup liner 11₁ is chosen so that it, in its relaxed state, i.e. non-contracted and non-expanded state, is smaller than the outer diameter of the teat to which it is to be attached. The teat cup liner 11₁ is made of a material that is vacuum impervious and insulates the teat from the applied vacuum. The teat cup liner 11₁ further provides a tight fit of the liner to the teat and firm support of the whole teat, with the exception of the lower, rounded part of the teat, which has to be free from the teat cup liner in order to enable milk extraction. The firm support of the teat is maintained through the entire milking session.

To obtain the desired tight-fitting feature of the teat cup liner 11 careful choice of material is required. The material has to be elastic enough to admit expansion of the teat cup liner 11 so as to allow attachment of it to the teat. The material also has to fit tight to the teat after attachment and during pulsating vacuum. When a vacuum level is provided by the vacuum source supply 3 at the first connection point, the teat cup liner 11 should expand easily. The material thus has to endure expansion and contraction to a degree so as to allow swift attachment and secure tight-fitting when in use. A material suitable for the teat cup liner comprises any elastic or thermoelastic material or compound, for example natural rubber such as latex, synthetic latex or silicone.

FIG. 4 illustrates a second embodiment of the teat cup liner 11₂ in accordance with the invention. This embodiment is similar to the first embodiment, but the teat cup liner 11₂ is “cut”, i.e. has no connection means to or comprises the short milk line. This means that no closed space 16 is formed between the teat cup shell 10 and the teat cup liner 11₂.

The teat cup liner 11₂ in accordance with the second embodiment may be made of a material that is vacuum impervious as in the first embodiment, but in a variant of this embodiment, the material used for the teat cup liner 11₂ is knitted or braided. The teat cup liner 11₂ is thereby vacuum pervious, i.e. not vacuum sealing. Such vacuum pervious teat cup liner 11₂ can be used outside the teat cup liner 11₁ in accordance with the first embodiment. That is, the vacuum pervious teat cup liner 11₂ is threaded on the teat cup liner 11₁ that is to be attached to the teat. Thereby additional support of the teat is provided, and the material properties of the teat cup liner 11₁ closest to the teat can be maintained. In particular, a teat cup liner made by braiding or knitting can be stretched in different directions without being stretched beyond the flow limit or yield point of the material.

An advantage of having the teat cup liner 11₂ being made with a number of small holes (e.g. using braided material) is that when vacuum is let through the holes this results in the holes acting as suction cups, which in turn provides a firm contact between the two teat cup liners. The teat cup liner is thereby firmly attached to the teat. There is then no risk of the teat slipping too far down in the teat cup 2, as the teat cannot slide in relation to the teat cup liner 11.

The invention is applicable to conventional milking systems, and when a conventional pulsating vacuum is utilized for cyclically collapsing the teat cup liner towards the teat, there is still contact between the teat cup liner and the teat along the whole circumference of the teat. That is, the teat cup liner is tight-fitting to the teat and supports the teat all through the milking session.

The tight-fitting support that the teat cup liner in accordance with the invention provides, prevents the vacuum from causing blood and tissue fluids to accumulate in tissue of the tip of the teat and the teat end does therefore not become congested. Further, as the diameter of the teat cup liner is, in its relaxed state, smaller than the outer diameter of the teat, the teat cup liner does not crawl and problems related to crawling are thereby eliminated.

The prior art teat cup liner becomes flat during the contraction, that is, when it collapses against the teat. The liner is then in contact with the teat on two opposing sides, but not at parts in between. Stated differently, the shape of the teat cup liner does not match and follow the shape of the teat during the contraction. This may result in the teat cup liner slapping or rubbing against the teat, which is uncomfortable for the animal. By means of the present invention, the teat cup liner is in contact with the whole teat, i.e. all around the teat, during the whole milking session. The pressure applied to the teat by the material properties of the teat cup liner is uniform essentially for the whole teat. That is, although the pressure is varying with a varying vacuum level, the whole teat is subjected to the same pressure by the teat cup liner. An elastic tight-fitting teat cup liner providing a firm support to a teat and subjecting only the lower, rounded part of the teat to vacuum is provided.

The pulsating vacuum provided for accomplishing the cyclic collapses of the teat cup liner against the teat may entail slapping of the teat, and rubbing of the liner against the teat. Further, the collapses of the teat cup liner may shorten the service life of a teat cup liner as cracks may arise in the liner due to the repeated collapses. In an embodiment of the invention, the vacuum applied is therefore non-pulsating, i.e. essentially constant during the whole milking session.

By applying a non-pulsating vacuum level to the teats of the animal, some of the disadvantages of having a pulsating vacuum are eliminated. In particular, there are no collapses of the teat cup liner against the teat as the vacuum level is essentially constant. Problems related to teat cup liner collapses may thus be alleviated; for example slapping of the teat cup liner against the teats is eliminated. Further, the milking system is more cost-efficient in that the pulsator system 7, schematically illustrated in FIG. 1, for providing the pulsating vacuum, can be omitted. The milking system 1 in accordance with this embodiment of the invention thus requires fewer components and therefore also less service and maintenance work. This is of particular importance for small-scale milking systems.

FIG. 5 illustrates a third embodiment of the teat cup liner 11₃. The teat cup liner 11₃ comprises a conical shape having an upper part that is broader than a lower part. By means of the conical shape the upper part of the teat cup liner 11₃ bears free from the teat throughout a whole milking session. Further, the lower part of the teat cup liner 11₃ supports the teat and fits tight only at the lower part of the teat, thereby subjecting only the lower, rounded part of the teat to the vacuum level provided by the vacuum supply source 3.

The conical shape and in particular the angle between a vertical line and the wall of the teat cup liner 11₃, i.e. the difference in diameter of the upper part and diameter of the lower part, can be chosen so as to fit all sizes of teats of the milking animals of a herd. The teat cup liner 11₃ having a certain angle then comes in supporting contact with the teat and fits tight at different heights along the teat, depending on teat size.

In this embodiment of the teat cup liner, the upper part of the teat cup liner does not necessarily fit tight to the teat, and there may be an atmospheric pressure in the upper part of the teat cup liner even after attachment to the teat. Thereby crawling of the teat cup liner is prevented also in this embodiment.

1-20. (canceled)

21. A milking system (1), comprising:
a vacuum supply source (3);
a teat cup (2),
said teat cup comprising a teat cup liner (11) and a teat cup shell (10),
said teat cup liner having a first attachment for connection to said teat cup at an upper end of said teat cup shell,
said teat cup liner mounted to said teat cup shell at the upper end of said teat cup shell, thereby forming a space (16) between said teat cup liner and said teat cup shell,
said teat cup shell having a wall facing said mounted teat cup liner, said space being located therebetween;
a first vacuum connection point (P1) to said vacuum supply source, the first vacuum point (P1) communicating a vacuum level into said space at an upper portion of said teat cup shell, wherein,
the vacuum level controls expansion of said teat cup liner thereby controlling a fit of the teat cup liner on a teat of an animal being milked to support and fit tight to the teat of the milking animal throughout a milking session;
a second vacuum connection point (P2) to said vacuum supply source, the second vacuum point communicating the vacuum level into a lower portion of said teat cup; and
a control device configured to maintain, in use, the vacuum level communicated into said space at the upper portion of said teat cup shell at the first connection point (P1) essentially equal to the vacuum level communicated into the lower portion of said teat cup at the second connection point (P2).

22. The milking system of claim 21, wherein,
said teat cup liner is attached to said teat cup shell only by said first attachment at the upper end of said teat cup shell, said teat cup liner otherwise being free of attachment to said teat cup shell, and
said space is a non-closed space.

23. The milking system of claim 22, wherein,
said first vacuum connection point (P1) to said vacuum supply source comprises an inlet connector (12) connected to said teat cup shell,
said inlet connector comprises a protruding part (13) that protrudes a length from the wall inwards into said space,
the protruding part is hollow and has an opening communicating the vacuum level into said space, the vacuum level within said space provided by said vacuum supply source sufficient to provide for the expansion and contraction of said teat cup liner,
said length said protruding part protrudes into said chamber limits expansion of said teat cup liner beyond a desired degree by the expanded teat cup liner bearing against the opening of the protruding part and preventing further vacuum from being supplied to said closed space, thereby controlling the fit of the teat cup liner on the teat of the animal being milked to support and fit tight to the teat of the milking animal throughout a milking session.

24. The milking system of claim 23, wherein, wherein the milking system is for a first type of animal, the length said protruding part protrudes into said chamber is a first length selected in dependence on teat sizes of the first type of animals.

25. The milking system of claim 23, wherein the length said protruding part protrudes into said chamber is adjustable.

26. The milking system of claim 21, further comprising:
a vacuum-pervious teat cup liner (11₂), arranged outside said teat cup liner and comprising a connection to said teat cup shell only at an upper end thereof, wherein,
said vacuum-pervious teat cup liner is free of any short milk line and is free of any connection to a short milk line.

27. The milking system of claim 26, wherein said vacuum-pervious teat cup liner comprises a braided or knitted material.

28. The milking system of claim 21, wherein the vacuum supply source is a non-pulsating vacuum supply source, and the system is free of any pulsating vacuum supply source.

29. The milking system of claim 21, wherein,
said teat cup liner (11₃) comprises a conical shape having a upper part is broader than a lower part,
said conical shape enabling said upper part to bear free from the teat throughout a whole milking session, and further enabling said lower part to support the teat and fit tight only at the lower part of the teat, thereby subjecting only the lower part of said teat to the vacuum level provided by said vacuum supply source (3).

30. The milking system of claim 21, wherein said teat cup liner comprises one of an elastic material and a thermoelastic material.

31. The milking system of claim 21, wherein, wherein an inside diameter of said teat cup liner in a relaxed state is smaller than an outside diameter of said teat.

32. The milking system of claim 21, wherein, wherein a vacuum level of said vacuum supply source (3) at a first vacuum connection point (P1) is arranged to be essentially constant.

33. The milking system of claim 23, wherein said opening of said protruding part comprises a grating (15).

34. The milking system of claim 21, wherein,
said teat cup liner has plural attachments for connection to said teat cup shell, the first attachment for connection attaching said teat cup liner to the upper end of said teat cup shell, a second attachment for connection attaching said teat cup liner to said teat cup shell at a lower part of said teat cup shell, the first and second connections, at least in part, defining the space as a closed space,
a lower part of said teat cup liner is a short milk tube, the short milk tube providing the second connection point (P2) to said vacuum supply source, the teat tip being subjected to a vacuum level of said vacuum supply source supplied at the second connection point, and
said teat cup liner comprises a shape supporting the whole teat, while subjecting only the teat tip of the teat to the vacuum level of said vacuum supply source.

35. The milking system of claim 34, wherein,
said first vacuum connection point (P1) to said vacuum supply source comprises an inlet connector (12) connected to said teat cup shell,
said inlet connector comprises a protruding part (13) that protrudes a length from the wall inwards into said closed space,
the protruding part is hollow and has an opening communicating the vacuum level into said space, the vacuum level within said space provided by said vacuum supply source sufficient to provide for the expansion and contraction of said teat cup liner,
said length said protruding part protrudes into said chamber limits expansion of said teat cup liner beyond a desired degree by the expanded teat cup liner bearing against the opening of the protruding part and preventing further vacuum from being supplied to said closed space, thereby controlling the fit of the teat cup liner on the teat of the animal being milked to support and fit tight to the teat of the milking animal throughout a milking session.

36. The milking system of claim 35, wherein, wherein the milking system is for a first type of animal, the length said protruding part protrudes into said chamber is a first length selected in dependence on teat sizes of the first type of animals.

37. The milking system of claim 35, wherein the length said protruding part protrudes into said chamber is adjustable.

38. A milking system (1), comprising:
a vacuum supply source (3); and
a teat cup (2),
said teat cup comprising a teat cup liner (11) and a teat cup shell (10),
said teat cup liner mounted to said teat cup shell and forming a closed space (16) between said teat cup liner and said teat cup shell,
said teat cup shell (10) having a wall facing said mounted teat cup liner;
an inlet connector (12) connected to said teat cup shell,
said inlet connector comprising a protruding part (13) that protrudes a length from the wall inwards into said closed space,
the protruding part being hollow and having i) an opening communicating a vacuum level into said closed space, ii) an ejector device (14), under a pulsating vacuum, providing a higher vacuum level within said teat cup than provided by said vacuum supply source and sufficient to provide for an expansion and contraction of said teat cup liner, and iii) and a first connection point (P1) to said vacuum supply source, wherein,
said length said protruding part protrudes into said chamber limits expansion of said teat cup liner beyond a desired degree by the expanded teat cup liner bearing against the opening of the protruding part and preventing further vacuum from being supplied to said closed space, thereby controlling the fit of the teat cup liner on a teat of an animal being milked to support and fit tight to the teat of the milking animal throughout a milking session.

39. The milking system of claim 38, wherein the length said protruding part protrudes into said chamber is adjustable.

40. The milking system of claim 38, wherein,
said teat cup liner has attachments for connection to said teat cup shell, a first connection to said teat cup shell at an upper end thereof and a second connection to said teat cup shell at a lower part thereof, the first and second connections, at least in part, defining the closed space,
a lower part of said teat cup liner is a short milk tube, the short milk tube providing a second connection point (P2) to said vacuum supply source, the teat tip being subjected to a vacuum level of said vacuum supply source supplied at the second connection point, and
said teat cup liner comprises a shape supporting the whole teat, while subjecting only the teat tip of the teat to the vacuum level of said vacuum supply source.
